(19) United States
(12) Patent Application Publication
(10) Pub. No.: US 2017/0239612 A1
(43) Pub. Date: Aug. 24, 2017

(54) Cold Solvent Gas Treating System

(71) Applicants: Suhas P. Mondkar, Houston, TX (US); P. Scott Northrop, The Woodlands, TX (US); Jenny P. Seagraves, Spring, TX (US); Ransdall K. Smith, Spring, TX (US); Shwetha Ramkumar, Cypress, TX (US)

(72) Inventors: Suhas P. Mondkar, Houston, TX (US); P. Scott Northrop, The Woodlands, TX (US); Jenny P. Seagraves, Spring, TX (US); Ransdall K. Smith, Spring, TX (US); Shwetha Ramkumar, Cypress, TX (US)

(21) Appl. No.: 15/436,203

(22) Filed: Feb. 17, 2017

Related U.S. Application Data
(60) Provisional application No. 62/297,476, filed on Feb. 19, 2016.
(60) Provisional application No. 62/299,296, filed on Feb. 24, 2016.

(51) Int. Cl. B01D 53/14; F25J 3/02; F25J 3/08; C10L 3/10

(52) U.S. Cl. CPC B01D 53/1468; B01D 53/1406; B01D 53/1475; C10L 3/104; C10L 3/103; F25J 3/0209; F25J 3/08; B01D 2252/20431; B01D 2252/20426; C10L 2290/541; C10L 2290/543; F25J 2220/66

(57) ABSTRACT

A method of removing impurities from a natural gas stream. A selective solvent is provided that absorbs a first impurity at a first rate and a second impurity at a second rate that is slower than the first rate. The solvent is cooled to a temperature below 60° F. to provide a cooled solvent. The cooled solvent is contacted with the natural gas stream, thereby generating a rich solvent that includes the first impurity. The rich solvent is removed from the natural gas stream, wherein an amount of the first impurity remaining in the natural gas stream is below a sales gas requirement.

### CROSS-REFERENCE TO RELATED APPLICATION

This application claims the benefit of U.S. Provisional Application No. 62/297,476, filed 19 Feb. 2016 and titled COLD SOLVENT GAS TREATING SYSTEM, and U.S. Provisional Application No. 62/299,296, filed 24 Feb. 2016 and titled COLD SOLVENT GAS TREATING SYSTEM. The entirety of each of these applications are incorporated by reference herein.

### FIELD

The present techniques relate to the separation of impurities from a gas stream. More specifically, the present techniques relate to the use of low-temperature solvents to remove impurities, such as hydrogen sulfide and carbon dioxide, from a gas stream.

### BACKGROUND

Raw natural gas often contains “acidic” impurities (notably carbon dioxide (CO₂), hydrogen sulfide (H₂S), mercaptans and other trace sulfur compounds) that must be removed prior to industrial or consumer use. A number of processes have been devised to remove these components and concentrate them into an “acid gas” stream consisting primarily of CO₂ and H₂S Among the more popular processes to treat natural gas are chemical solvents (e.g., amines), physical solvents (e.g., DEPG or Selexol™ or Coastal AGR®) and hybrid solvents (mixtures of physical and chemical solvents, e.g., Sulfinol). These solvent processes typically involve counter-currently contacting the raw natural gas in a packed or trayed column with a “lean” solvent which absorbs the undesirable components. The treated (“sweet”) gas can be further processed (e.g., for liquids recovery), sold into a pipeline, used for liquefied natural gas (LNG) feed, or as feedstock for gas-to-liquids conversion. The “rich” solvent can be regenerated by stripping the acidic components from it to make it “lean,” so that the solvent can be recycled in the process.

In some cases, it is preferable to absorb virtually all of the H₂S to a certain specification (e.g., 4 ppm), while “slipping” the CO₂ to the treated gas. This is known as “selective treating”.

Tertiary amines like methyl diethanol amine (MDEA) are often used for selective treating. H₂S reacts quickly with these amines, with the reaction resulting in amine-hydrosulfide salt formation:

H₂S+R₁R₂R₃N . . . >R₁R₂R₃N H⁺+HS— (1)

where R₁, R₂, and R₃ are alkyl, aliphatic, or other organic moieties that may be the same, or different from one another. Since none of R₁, R₂, and R₃ are hydrogen (H) atoms, there is no way for CO₂ to react with the amine to form carbamates. Instead, CO₂ is forced to react with the amine to form bicarbonates via the slow route.

An alternative way to prevent CO₂ from reacting directly with the amine is to utilize “steric hindrance.” In this case, at least one of R₁, R₂, or R₃ is a bulky substituent like a tertiary butyl group, and one is an H atom, making the nitrogen atom a stronger base. The bulky substituent prevents the CO₂ from accessing the H atom attached to the nitrogen atom. An example is ethanol-ethoxy tert-butyl amine, one of the family of Flexsorb absorbents.

Water is normally used as the co-solvent with these amines. The water dissolves both the amine and the resulting salt. However, water provides a route for CO₂ to react according to:

CO₂+H₂O< . . . >[H₂CO₃]< . . . >H⁺+HCO₃₋. (2)

The proton (H⁺) formed in reaction (2) reacts with the amine, with the result of forming a bicarbonate salt. While reaction (2) is slow relative to reaction (1), it ultimately limits the H₂S selectivity that aqueous tertiary amines can attain. This limitation is undesirable.

It has been proposed that H₂S selectivity of generic amines be enhanced by lowering the operating temperature of the absorption column (“Decreasing Contactor Temperature Could Increase Performance,” by Lunsford, K. and McIntyre, G., Proceedings of the Seventy-Eighth Gas Processors Association Annual Convention. Nashville, Tenn., 1999: 121-127). While lower temperatures would slow both reactions (1) and (2), reaction (1) is so fast that it would be virtually unaffected. Meanwhile, CO₂ reaction via (2) would be slowed substantially by lower temperature, thus reducing its rate of absorption. The viscosity of the solution would increase as well, further retarding mass transfer of CO₂ and increasing solvent selectivity. Note, however, that there is an upper limit to solution viscosity beyond which normal mass transfer devices (trays, packing, etc.) may no longer operate properly. Diluting the amine solution with additional water may keep the viscosity in the normal operating band at these low temperatures (40° F.-80° F.). Alternatively, there may be other additives that can be used to reduce the viscosity of the solution while maintaining the amine concentration at higher levels.

The problem is that it is very costly to cool large volumes of gas and amine to the temperatures needed to substantially reduce the CO₂ reaction rate, so no further work appears to have been done in this area.

### SUMMARY

In an aspect, a method of removing impurities from a natural gas stream is provided. A selective solvent absorbs a first impurity at a first rate and a second impurity at a second rate that is slower than the first rate. The solvent is cooled to a temperature below 60° F. to provide a cooled solvent. The cooled solvent is contacted with the natural gas stream, thereby generating a rich solvent that includes the first impurity. The rich solvent is removed from the natural gas stream, wherein an amount of the first impurity remaining in the natural gas stream is below a sales gas requirement.

### BRIEF DESCRIPTION OF THE FIGURE

FIG. 1 is a flowchart of a method according to disclosed aspects.

### DETAILED DESCRIPTION

Various specific aspects, embodiments, and versions will now be described, including definitions adopted herein. Those skilled in the art will appreciate that such aspects, embodiments, and versions are exemplary only, and that the invention can be practiced in other ways. Any reference to the “invention” may refer to one or more, but not necessarily all, of the embodiments defined by the claims. The use of headings is for purposes of convenience only and does not limit the scope of the present invention. For purposes of clarity and brevity, similar reference numbers in the several FIGURES represent similar items, steps, or structures and may not be described in detail in every FIGURE.

All numerical values within the detailed description and the claims herein are modified by “about” or “approximately” the indicated value, and take into account experimental error and variations that would be expected by a person having ordinary skill in the art.

As used herein, “cooling” broadly refers to lowering and/or dropping a temperature and/or internal energy of a substance by any suitable, desired, or required amount. Cooling may include a temperature drop of at least about 1° C., at least about 5° C., at least about 10° C., at least about 15° C., at least about 25° C., at least about 35° C., or least about 50° C., or at least about 75° C., or at least about 85° C., or at least about 95° C., or at least about 100° C.

The term “gas” is defined as a substance or mixture of substances in the gaseous state as distinguished from the liquid or solid state. Likewise, the term “liquid” means a substance or mixture of substances in the liquid state as distinguished from the gas or solid state.

As used herein, the term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. The natural gas stream may also contain ethane (C₂), higher molecular weight hydrocarbons, and one or more acid gases. The natural gas may also contain minor amounts of contaminants such as water, nitrogen, iron sulfide, wax, and crude oil.

Certain embodiments and features may be described using a set of numerical upper limits and a set of numerical lower limits. It should be appreciated that ranges from any lower limit to any upper limit are contemplated unless otherwise indicated. All numerical values are “about” or “approximately” the indicated value, and take into account experimental error and variations that would be expected by a person having ordinary skill in the art.

All patents, test procedures, and other documents cited in this application are fully incorporated by reference to the extent such disclosure is not inconsistent with this application and for all jurisdictions in which such incorporation is permitted.

Acid gas (i.e., H₂S and CO₂) removal from natural gas is an expensive and equipment-intensive process. Removal of hydrogen sulfide (H₂S) from natural gas streams is especially complicated due to the safety, health, and environmental considerations required when working with that toxic substance. The presence of H₂S and the processing of sulfur by-products into solid sulfur, or injection of H₂S-containing gas require great care and attention.

Acid gas is removed from natural gas in a variety of ways in the upstream natural gas industry, depending on the concentrations, pressures, and final disposition of the gas and contaminants. Most natural gas pipelines in the US have a specification that requires sales gas to maintain concentrations of less than 4 ppm H₂S and 2 vol % CO₂ in order to use the pipeline for transportation. This requirement is in place to maintain the integrity of the pipeline by reducing corrosion and ensuring public safety. The acid gas concentration in the raw gas may require simultaneous removal of CO₂ and H₂S, removal of only CO₂, or removal of only H₂S to meet these pipeline regulations.

In Selective H₂S Removal, the goal is to remove H₂S to meet a certain specification while leaving as much CO₂ as possible in the gas stream up to the application limit. Selective treating would be used when the gas already meets the CO₂ specification, or when H₂S is to be removed to avoid safety and corrosion issues, or when a downstream process (such as Controlled Freeze Zone (CFZ)) is used to recover “clean” CO₂.

Selective H₂S removal is typically achieved with tertiary amines such as methyldiethanol amine (MDEA), or sterically-hindered amine-based solvents such as ExxonMobil's FLEXSORB SE and FLEXSORB SE Plus.

These selective solvents take advantage of the kinetic differences in the absorption reactions for CO₂ and H₂S with these amines. These amines react very quickly with H₂S, but react with CO₂ relatively slowly since the carbamate reaction is not available. Reactions with H₂S and CO₂ are both reversible so that the solvent can be regenerated. Since the selectivity of these solvents is based on differing reaction rates, the residence time in absorption towers is an important design parameter to maximize H₂S uptake while minimizing the time allowed for CO₂ reaction.

The selectivity of the solvent is defined as the amount of H₂S that is absorbed relative to the amount of CO₂. Solvents with high selectivity favor absorption of H₂S and are preferred for selective H₂S removal applications because they result in smaller solvent circulation rates, and consequently smaller (and less expensive) equipment. The resulting acid gas (concentrated H₂S+CO₂) stream is also richer in H₂S, making that stream smaller. The acid gas injection, or sulfur recovery unit handling that acid gas is consequently reduced in size, as is the cost of the equipment associated with handling that stream.

Current oil and gas industry exploration has seen an increase in sour natural gas assets being found. Furthermore, many existing producing assets are experiencing reservoir souring which increases the H₂S concentration in produced gas. Sour gas treating, and specifically Selective H₂S Removal, has been a major part of the gas treating industry for decades. These facilities contribute to process complexity, capex, opex, weight, space, and footprint. Improvements in space, weight, footprint, operability, or reliability in these processes are in high demand in the natural gas treating industry.

No solvent is perfectly selective; that is, some CO₂ always reacts with the amine solvent by one or more mechanisms. The past strategy has been to remove or restrict certain reaction routes between the amine and CO₂. It has been an ongoing goal of the industry to improve H₂S-selectivity.

H₂S reacts very quickly with aqueous-based solvents like amines, with the reaction occurring in milliseconds once the H₂S reaches the liquid. This is why H₂S mass transfer is generally considered “gas-side” controlled. The reactions can be summarized as follows:

(1) R—NH₂+H₂O→R—NH₂H++OH— (fast reaction)
(2) H₂S+H₂O→H₃O⁺+SH— (fast reaction)
(3) H₃O⁺+OH⁻→2H₂O (fast reaction)
(4) R—NH₂+H₂S→R—NH₂H⁺+SH— (overall net reaction is fast)
(5) CO₂+H₂O→[H₂CO₃] (slow reaction)
(6) [H₂CO₃]+H₂O→H₃O⁺+HCO₃⁻ (slow reaction)
(7) R—NH₂+H₂O+CO₂→R—NH₂H⁺+HCO₃⁻ (overall bicarbonate reaction is slow)
(8) CO₂+RH₂N→RHN⁺HCOO⁻ (carbamate reaction is relatively fast)
(9) R₂N⁺HCOO⁻+R₂HN→R₂NH₂⁺R₂NCOO⁻ (carbamate reacts with another amine molecule)

Reactions 1-3 sum to reaction 4, which represents the overall reaction between H₂S and amine. The rate-limiting step is reaction 2, but it is still very fast.

Reactions 5 and 6 are much slower than 4, and represent CO₂ conversion to carbonic acid ([H₂CO₃]), then the carbonic acid decomposing into hydronium and bicarbonate ions in Reaction 7.

With reactions 1 and 3, they sum to reaction 8, which applies to all amines.

Reaction 9 involves reaction of CO₂ with the H attached to the amino nitrogen to form a carbamate. The reaction is relatively fast, and provides a direct route for the CO₂ to react with primary and secondary amines.

If there is no H attached to the N (as for tertiary amines), or if steric hindrance blocks the CO₂ from reacting with the H (FLEXSORB), reactions 5 and 6 cannot occur. Thus, only the slow bicarbonate reaction 7 is available to the CO₂.

It has been proposed that H₂S selectivity of amines be enhanced by lowering the operating temperature of the absorption column (“Decreasing Contactor Temperature Could Increase Performance,” by Lunsford, K. and McIntyre, G., Proceedings of the Seventy-Eighth Gas Processors Association Annual Convention. Nashville, Tenn., 1999: 121-127). While lower temperatures would slow both reactions 4 and 7, reaction 4 is so fast that it would be effectively unchanged. Meanwhile, CO₂ reaction via reaction 7 would be slowed substantially by lower temperature, thus reducing its rate of absorption. The viscosity of the solution would increase as well, further retarding mass transfer of CO₂ and increasing solvent selectivity. Note, however, that there is an upper limit to solution viscosity beyond which normal mass transfer devices (trays, packing, etc.) may no longer operate properly. Diluting the amine solution with additional water may keep the viscosity in the normal operating band at these low temperatures (40-80° F.). Alternatively, there may be other additives that can be used to reduce the viscosity of the solution while maintaining the amine concentration at higher levels.

Interestingly, there appears to have been no uptake, or follow-up on the information presented in the Lunsford paper. Actually, of the 5 case studies presented in that paper, only one employed MDEA, and it was mixed with DEA. Thus, it was not an H₂S-selective case, so they could not anticipate the great benefit with respect to improved H₂S selectivity. It is possible that warm ambient cases were contemplated where cooling the incoming sour gas would a) require significant refrigeration horsepower (especially given the latent heat of condensation of water, and to a lesser extent that of hydrocarbons) b) handling condensed water in the presence of H₂S and CO₂.

While the Lunsford paper mentioned that the performance of selective amines could be improved by the use of cooler temperatures, it did not show the remarkable and unexpected reduction in solvent circulation that can be obtained by operating at temperatures less than 60° F. Simulations have been performed that indicate reductions of solvent circulation rate by as much as 90% are potentially possible in some cases. This phenomenal reduction would result in much smaller treating equipment, and may even enable offshore gas treating in some instances.

For applications where the inlet gas temperature is already relatively low (e.g., gas coming through a subsea pipeline), a tertiary amine, or a sterically-hindered amine could selectively remove H₂S while slipping virtually all of the CO₂. In fact, reducing the solvent circulation rate further reduces the CO₂ uptake, thereby improving selectivity. An additional benefit is that with less CO₂ co-absorption, less heat of absorption is generated. This keeps the temperature of the solvent low, which in turn reduces CO₂ uptake, which means that the solvent rate can be reduced further. This cycle of reducing cold solvent circulation rate that reduces CO₂ uptake that reduces heat generation that reduces CO₂ reaction is the basis for this “snowball” effect that gives the surprising result of greatly reduced circulation rate. The combination of selective amine and temperature was not simply additive, but in fact multiplicative. As mentioned before, a more concentrated acid gas stream also reduces CAPEX and OPEX of the overall project.

The greatly reduced circulation rate makes the solvent more amenable to cooling or chilling. The cooling may be done by air, seawater, cooling tower, refrigeration, or by cross-exchange with the cool gas to be treated. In general, it is desirable to keep the incoming solvent at least ˜10° F. higher than the gas to avoid condensation of hydrocarbons into the amine, which could cause deleterious foaming.

Another consideration for these high-pressure applications is that the gas temperatures should be kept ˜10° F. or more above the hydrate formation temperature at all points in the process as the gas is being contacted with aqueous solvent.

This technique can also be applied to acidified amines like Flexsorb SE PLUS, which use small amounts of acid to aid stripping and reduce the lean loading of the amine.

For applications where the inlet gas temperature is already low (e.g., gas coming through a subsea pipe), the use of a tertiary amine, or a sterically-hindered amine to selectively remove H₂S can reduce the solvent circulation rate to such a low level that cooling the solvent is potentially viable. The surprising element is that slipping more CO₂ with MDEA or Flexsorb reduced the required circulation rate, which reduced CO₂ pickup, which reduced the heat generated by reaction, which further reduced the CO₂ absorption rate, which further reduced circulation rate, starting the cycle over again. This “snowball” effect drove the solvent circulation rates to very low levels, which was totally unexpected. The effect can be further magnified by shortening the contact time between the gas and liquid. This technique can also be applied to acidified amines like Flexsorb SE PLUS, which use small amounts of acid to aid stripping and reduce the lean loading of the amine. The combination of selective amine, lower temperature, contact time, and acidification was not simply additive, but in fact multiplicative. In one case, the circulation rate was driven down by more than a factor of twenty.

Combination with Downstream Cold Processes

The use of cold gas/chilled solvent is particularly synergistic with downstream cold processing, which may include cryogenic distillation processes such as the Controlled Freeze Zone (CFZ) technology, which is described in further detail in U.S. patent application Ser. No. 13/805,645 with filing date of 19 Dec. 2012 and titled “Cryogenic Systems for Removing Acid Gases from a Hydrocarbon Gas Stream using Co-current Separation Devices,” the disclosure of which is incorporated herein by reference. In this case, it is desirable to remove H₂S, but keep CO₂ in the treated gas stream. By having a highly-selective solvent that removes essentially all of the H₂S in a gas stream upstream of a CFZ unit, the liquid CO₂ that the CFZ generates will be “clean” enough to be sold for enhanced oil recovery use. The gas has to be chilled anyway for the CFZ, so the line-up would be: chill raw gas to 10° F. above hydrate point (collecting and treating all collected liquids), treat with cold MDEA or Flexsorb, dehydrate with glycol or mole sieve, then treat to separate the carbon dioxide with a process such as CFZ.

Combination with Contacting Technologies

The combination of a selective H₂S solvent and contacting technologies, such as the cMIST technology, provides the unique advantage of reduced CO₂ pickup through significantly reduced residence time. The cMIST contactor technology has been described, for example, in U.S. patent application Ser. No. 14/760,539, filed 13 Jul. 2015 and titled “Contacting a Gas Stream with a Liquid Stream,” the disclosure of which is incorporated by reference herein in its entirety. With only a very short time for reaction, the fast H₂S reaction dominates, minimizing the pickup of CO₂. Furthermore, as the amine solution loads with H₂S, its pH drops due to the consumption of OH—. The invention increases the potential application range for cMIST contactors, which is normally limited to 10-12 vol % liquid in the treating device. Reducing liquid circulation rate means that more applications are potentially in play for cMIST.

This advantage can be quantified by examining the analog of glycol contacting for dehydration of natural gas. Initial residence times for dehydration in a single stage of contacting was measured under a range of conditions (500 & 1000 psia, 90° F., 2.0-11.4 Mscfd, 1.5-11.3 gal glycol circulated per lb H₂O absorbed, and 98.7 wt % and 99.9 wt % triethyleneglycol in solution). The tests were performed with a single stage of contacting and through modeling it is known that dehydration to pipeline specification can be achieved in two cMIST dehydration stages. The values for both cases are compared with that of a typical glycol contactor providing a dehydrating treatment for large volumes of natural gas.

| | Gas Velocity | Residence Time | |
|---|---|---|---|
| cMIST contactors | 2.8-7.4 m/s | 9-24 ft/s | 0.03-0.1 s |
| cMIST contactors - two | 2.8-7.4 m/s | 9-24 ft/s | 0.06-0.2 s |
| stage estimate | | | |
| Typical Glycol Contacting | 0.5-0.6 m/s | 1-2 ft/s | 8-15 s |
| Tower | | | |

This data can be applied to what is expected for H₂S absorption processes. The cMIST contactor unit shows residence times up to 2 orders of magnitude lower than that of a typical contactor. The advantages of this invention are two-fold:
Highly selective solvents will show even higher selectivity in the cMIST contactor device, resulting in both smaller equipment (previously described cMIST contactor advantages) and enhanced selectivity (reduced solvent circulation, smaller regeneration equipment, reduced solvent inventory requirements, etc.)
Solvents that may allow too high of CO₂ slip for a given application could be used with cMIST contactor equipment to meet treating specification. This would result smaller equipment (previously described cMIST contactor advantages) and being able to use a less expensive solvent.

The invention is focused on the unique advantages that arise out of the combination of a selective solvent with the unique characteristics of the cMIST contactor equipment. The new functionality and advantages (reduced equipment size, weight, footprint, etc.) are achieved only through the combination of the solvent and device. Both will work independently, but the combination provides unique functionality.

This invention does not specify a particular solvent must be used, but any solvent that is used to selectively remove H₂S over CO₂ may be used. This includes but is not limited to primary amines (monoethanolamine (MEA), 2(2-aminoethoxy) ethanol (aka Diglycolamine® (DGA), etc.), secondary amines (methyldiethanolamine (MDEA), diisopropanolamine (DIPA), etc.), tertiary amines (triethyleneamine), hindered amines (FLEXSORB SE, 2-amino-2-methyl-1-propanol (AMP), etc.), or formulated amines (FLEXSORB SE PLUS, UCARSOL family of products, formulated MDEA solutions, etc.).

Enhanced incentives exist and were envisioned with this invention through the combination of FLEXSORB SE and FLEXSORB SE PLUS with the cMIST technology.

Presaturation with CO₂

In another embodiment, a semi-lean stream of selective amine may be saturated with a small amount of CO₂ at warm temperature, then the solvent is cooled to the operating temperature. H₂S would react to kick off some of the CO₂, but the net heat of the reaction would be near zero, helping to maintain selectivity.

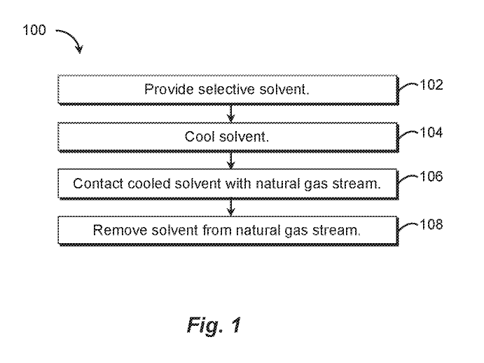

FIG. 1 is a flowchart 100 showing a method according to disclosed aspects. At block 102, a selective solvent is provided that reacts with a first impurity at a first rate and a second impurity at a second rate that is slower than the first rate. The first impurity may be hydrogen sulfide and the second impurity may be carbon dioxide. At block 104 the solvent is cooled to a temperature below 60° F. to provide a cooled solvent. At block 106 the cooled solvent is contacted with the natural gas stream, thereby generating a rich solvent that includes the first impurity. At block 108 the rich solvent is removed from the natural gas stream. The amount of the first impurity remaining in the natural gas stream is below a sales gas requirement.

Aspects of the disclosure may include any combinations of the methods and systems shown in the following numbered paragraphs. This is not to be considered a complete listing of all possible aspects, as any number of variations can be envisioned from the description above.

1. A method of removing impurities from a natural gas stream, comprising:

providing a solvent that absorbs a first impurity at a first rate and a second impurity at a second rate that is slower than the first rate;

cooling the solvent to a temperature below 60° F. to provide a cooled solvent;

contacting the cooled solvent with the natural gas stream, thereby generating a rich solvent that includes the first impurity; and

removing the rich solvent from the natural gas stream, wherein an amount of the first impurity remaining in the natural gas stream is below a sales gas specification.

2. The method of paragraph 1, wherein the first impurity is hydrogen sulfide.

3. The method of paragraph 1, wherein the second impurity is carbon dioxide.

4. The method of paragraph 1, wherein the predetermined temperature is below 60° F.

5. The method of paragraph 1, wherein the solvent is cooled using seawater.

6. The method of paragraph 1, wherein the solvent is cooled by one or more of air, refrigeration, a cooling tower, and by cross-exchange with the natural gas.

7. The method of paragraph 1, further comprising:

maintaining the temperature of the cooled solvent at least 10° F. higher than a temperature of the natural gas, to avoid condensation of hydrocarbons into the solvent.

8. The method of paragraph 1, further comprising:

maintaining a temperature of the natural gas at least 10° F. higher than a hydrate formation temperature while contacting the natural gas with the cooled solvent.

9. The method of paragraph 1, wherein the solvent is an amine-based solvent.

10. The method of paragraph 9, wherein the amine-based solvent includes an acidified amine.

11. The method of paragraph 1, wherein the solvent comprises one or more of a primary amine, a secondary amine, a tertiary amine, and a formulated amine.

12. The method of paragraph 1, wherein the solvent comprises a sterically hindered amine.

13. The method of paragraph 1, further comprising:

cooling or chilling the natural gas stream prior to contacting the cooled solvent with the natural gas stream.

14. The method of paragraph 13, wherein the natural gas stream is cooled or chilled to a temperature that is 10° F. above a hydrate formation temperature prior to cooling or chilling the natural gas stream.

15. The method of paragraph 13, wherein the natural gas stream is cooled by heat exchange with seawater as the natural gas stream is transported through a subsea pipe.

16. The method of paragraph 1, further comprising:

saturating the solvent with the second impurity prior to cooling the solvent.

17. The method of paragraph 1, further comprising:

after removing the rich solvent from the natural gas stream, removing the second impurity from the natural gas stream using a cryogenic distillation process.

18. The method of paragraph 1, further comprising:

after removing the rich solvent from the natural gas stream, removing the second impurity from the natural gas stream using a co-current contacting process.

19. The method of paragraph 1, further comprising:

reducing a rate that the solvent is contacted with the natural gas stream, to thereby reduce absorption of the second impurity by the solvent.

While the foregoing is directed to aspects of the present disclosure, other and further aspects of the disclosure may be devised without departing from the basic scope thereof, and the scope thereof is determined by the claims that follow.

What is claimed is:

1. A method of removing impurities from a natural gas stream, comprising:
providing a solvent that absorbs a first impurity at a first rate and a second impurity at a second rate that is slower than the first rate;
cooling the solvent to a temperature below 60° F. to provide a cooled solvent;
contacting the cooled solvent with the natural gas stream, thereby generating a rich solvent that includes the first impurity; and
removing the rich solvent from the natural gas stream, wherein an amount of the first impurity remaining in the natural gas stream is below a sales gas specification.

2. The method of claim 1, wherein the first impurity is hydrogen sulfide.

3. The method of claim 1, wherein the second impurity is carbon dioxide.

4. The method of claim 1, wherein the predetermined temperature is below 60° F.

5. The method of claim 1, wherein the solvent is cooled using seawater.

6. The method of claim 1, wherein the solvent is cooled by one or more of air, refrigeration, a cooling tower, and by cross-exchange with the natural gas.

7. The method of claim 1, further comprising:
maintaining the temperature of the cooled solvent at least 10° F. higher than a temperature of the natural gas, to avoid condensation of hydrocarbons into the solvent.

8. The method of claim 1, further comprising:
maintaining a temperature of the natural gas at least 10° F. higher than a hydrate formation temperature while contacting the natural gas with the cooled solvent.

9. The method of claim 1, wherein the solvent is an amine-based solvent.

10. The method of claim 9, wherein the amine-based solvent includes an acidified amine.

11. The method of claim 1, wherein the solvent comprises one or more of a primary amine, a secondary amine, a tertiary amine, and a formulated amine.

12. The method of claim 1, wherein the solvent comprises a sterically hindered amine.

13. The method of claim 1, further comprising:
cooling or chilling the natural gas stream prior to contacting the cooled solvent with the natural gas stream.

14. The method of claim 13, wherein the natural gas stream is cooled or chilled to a temperature that is 10° F. above a hydrate formation temperature prior to cooling or chilling the natural gas stream.

15. The method of claim 13, wherein the natural gas stream is cooled by heat exchange with seawater as the natural gas stream is transported through a subsea pipe.

16. The method of claim 1, further comprising:
saturating the solvent with the second impurity prior to cooling the solvent.

17. The method of claim 1, further comprising:
after removing the rich solvent from the natural gas stream, removing the second impurity from the natural gas stream using a cryogenic distillation process.

18. The method of claim 1, further comprising:
after removing the rich solvent from the natural gas stream, removing the second impurity from the natural gas stream using a co-current contacting process.

19. The method of claim 1, further comprising:
reducing a rate that the solvent is contacted with the natural gas stream, to thereby reduce absorption of the second impurity by the solvent.
